(19) United States
(12) Patent Application Publication
(10) Pub. No.: US 2006/0077540 A1
(43) Pub. Date: Apr. 13, 2006

(54) Compound microscope

(75) Inventor: Hirofumi Miyamoto, Niiza-shi (JP)

Correspondence Address: Scully, Scott, Murphy & Presser, 400 Garden City Plaza, Garden City, NY, 11530-3319, US

(73) Assignee: Olympus Corporation, Tokyo (JP)

(21) Appl. No.: 11/238,586

(22) Filed: Sep. 29, 2005

(30) Foreign Application Priority Data
Sep. 29, 2004 (JP) 2004-285340

(51) Int. Cl. G02B 21/36

(52) U.S. Cl. 359/369

(57) ABSTRACT

While an optical microscope is acquiring image data, the physical-property data acquired by a scanning probe microscope is analyzed and a display unit displays the results of the analysis of the physical-property data. While the scanning probe microscope is acquiring the physical-property data, the image data acquired by the optical microscope is analyzed and the display unit displays the results of the analysis of the image data.

### CROSS-REFERENCE TO RELATED APPLICATIONS

This application is based upon and claims the benefit of priority from prior Japanese Patent Application No. 2004-285340, filed Sep. 29, 2004, the entire contents of which are incorporated herein by reference.

### BACKGROUND OF THE INVENTION

1. Field of the Invention

The present invention relates to a compound microscope comprising an optical microscope and a scanning probe microscope (SPM). The optical microscope is, for example, a laser scanning microscope (LSM) that acquires data representing a two-dimensional image of a sample at resolution of sub-micron order. The scanning probe microscope is configured to acquire data representing the physical properties of the sample, including the shape of the sample, at higher resolution of the two-dimensional shape acquired by the optical microscope.

2. Description of the Related Art

Jpn. Pat. Appln. KOKAI Publication No. 10-142238 discloses a compound microscope that comprises, for example, a scanning probe microscope and an optical microscope attached to the scanning probe microscope. The two microscopes can therefore be used as a single unit. The compound microscope has a monitor, an instructing unit, and a controller. The monitor is provided common to the scanning probe microscope and the optical microscope. The instructing unit sets a magnification at which the monitor should display images for observation. The controller selects the scanning probe microscope or the optical microscope in accordance with the magnification set by the instructing unit. The microscope thus selected is used to acquire image data of a sample at the magnification, and the monitor displays an image represented by the image data.

When the magnification is set, either the scanning microscope or the optical microscope is automatically selected in accordance with the magnification. (Namely, the SPM mode or the optical-microscope mode is automatically selected.) If the magnification set is high, the scanning probe microscope is selected and starts operating. The probe of the scanning probe microscope is moved in the X, Y and Z directions. The microscope generates signals Vx, Vy and Vz that represent the distances the probe has been moved in the X, Y and Z directions, respectively. The signals Vx, Vy and Vz are stored in a storage means. The signals Vx, Vy and Vz are combined into a video signal that represents an image of the sample. The video signal is supplied to the monitor. The monitor displays the image of the sample, which shows the surface condition of the sample.

The magnification set may be low. In this case, the optical microscope is selected and starts operating. The observation camera of the optical microscope photographs a sample and generates a video signal that represents an image of the sample. The video signal is supplied to the monitor through an image-switching unit. The monitor displays the image of the sample, which shows the surface condition of the sample.

### BRIEF SUMMARY OF THE INVENTION

According to a main aspect of this invention, there is provided a compound microscope that comprises: an optical microscope which acquires image data representing an image of an sample; a scanning probe microscope which acquires physical-property data representing physical properties of the sample; a storage unit which stores the image data and physical-property data acquired by the optical microscope and scanning probe microscope, respectively; an data-analyzing unit which analyzes the physical-property data stored in the storage unit, while the optical microscope is acquiring the image data, and which analyzes the image data stored in the storage unit, while the scanning probe microscope is acquiring the physical-property data; and a display unit which displays results of analysis that the data-analyzing unit performs on the physical-property data stored in the storage unit, while the optical microscope is acquiring the image data, and which displays results of analysis that the data-analyzing unit performs on the image data stored in the storage unit, while the scanning probe microscope is acquiring the physical-property data.

### BRIEF DESCRIPTION OF THE SEVERAL VIEWS OF THE DRAWING

FIG. 1 is a diagram showing the configuration of a compound microscope according to a first embodiment of the invention;

FIG. 2 is a diagram depicting the optical microscope unit incorporated in the compound microscope;

FIG. 3 is a diagram illustrating the control-menu screen D of the display unit that the compound microscope has;

FIG. 4 shows some images that the display unit of the compound microscope may display;

FIG. 5 shows a thee-dimensional image acquired by the scanning laser microscope unit incorporated in the compound microscope;

FIG. 6 represents an extended focus image acquired by the scanning laser microscope unit; and

FIG. 7 is a diagram depicting the major components of a compound microscope according to a second embodiment of the present invention.

### DETAILED DESCRIPTION OF THE INVENTION

The first embodiment of this invention will be described, with reference to the accompanying drawings.

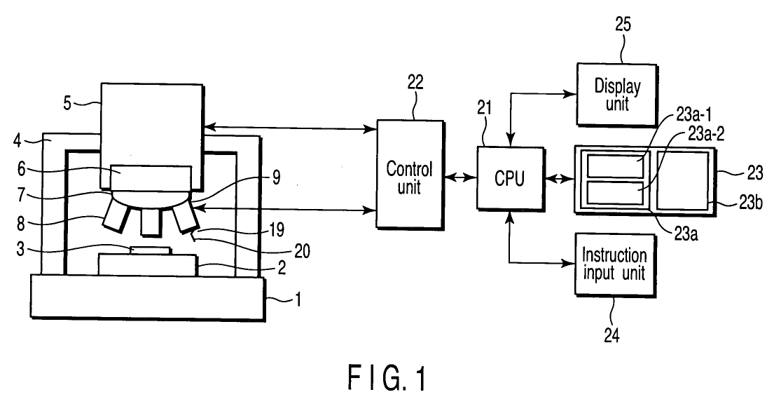

FIG. 1 shows the configuration of the compound microscope. The compound microscope has a vibration-free mount 1, an XY stage 2, and a gantry frame 4, an optical microscope unit 5, a Z-drive mechanism 6, a revolver 7, objective lenses 8, and a scanning probe microscope (SPM) unit 9. The XY stage 2 is provided on the vibration-free mount 1. The XY stage 2 holds a sample 3. The gantry frame 4 stands on the vibration-free mount 1 and holds the optical microscope unit 5.

The optical microscope unit 5 can acquire data representing images of at least two dimensions, including an optical image of the sample 3 (i.e., optical-microscope image). The Z-drive mechanism 6 is coupled to the lower surface of the optical microscope unit 5, which faces the YX stage 2. The revolver 7 is secured to the lower surface of the Z-drive mechanism 6. The Z-drive mechanism 6 can move the revolver 7 up and down. The revolver 7 can rotate with respect to the Z-drive mechanism 6. The revolver 7 holds the objective lens 8 and the SPM unit 9. The objective lens 8 has different magnifications. Thus, when the revolver 7 is rotated, one of the objective lens 8, which has the desired magnification, or the SPM unit 9 comes to face the sample 3 placed on the XY stage 2.

The optical microscope unit 5 has an optical system that can acquire data representing images of at least two dimensions. It is more desired that the optical microscope unit 5 have an optical system that can acquire data that represents a three-dimensional image of the sample 3. The optical microscope unit 5 may be a scanning laser microscope unit that can acquire data representing a three-dimensional image of the sample 3 (hereinafter referred to as “shape data”). Nonetheless, the optical microscope unit 5 is not limited to a scanning laser microscope unit. It may be an optical system of any other type that can acquire data that represents images of at least two dimensions.

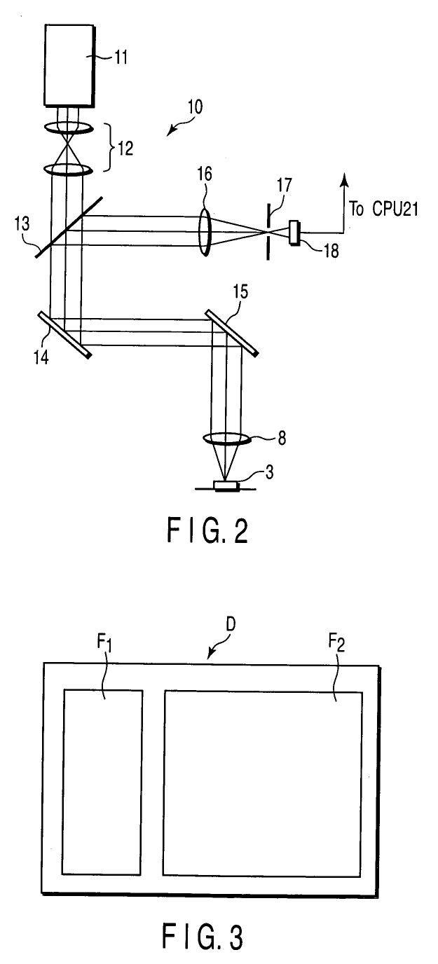

FIG. 2 depicts the configuration of a scanning laser microscope unit 10 that is used as optical microscope unit 5. The scanning laser microscope unit 10 has a light source 11, a beam expander 12, a half-mirror 13, two galvano-mirrors 14 and 15, and an objective lens 8.

The light source 11 emits a laser beam. The beam expander 12 increases the diameter of the laser beam emitted from the light source 11. The half-mirror 13 is located in the optical path of the laser beam that has passed through the beam expander 12. The first galvano-mirror 14 reflects the laser beam coming from the half-mirror 13, in the Y-axis direction. The second galvano-mirror 15 reflects the laser beam coming from the first galvano-mirror 14, in the X-axis direction. The objective lens 8 focuses the laser beam coming from the second galvano-mirror 15.

As indicated above, the beam expander 12 increases the diameter of the laser beam emitted from the light source 11. The laser bean passes through the half-mirror 13 and reaches the first galvano-mirror 14. The first galvano-mirror 14 reflects the laser beam in, for example, the Y-axis direction. The second galvano-mirror 15 reflects this laser beam in, for example, the X-axis direction. As a result, the beam spot that the laser beam focused by the objective lens 8 forms on the sample 3 moves in the X-axis and Y-axis directions.

The scanning laser microscope unit 10 has an image-forming lens 16, a pinhole plate 17, and a light-receiving element 18. The image-forming lens 16 focuses the light beam reflected by the half-mirror 13 at the pinhole made in the pinhole plate 17. The pinhole is located at a point where the laser beam is focused by the objective lens 8. The light-receiving element 18 detects the intensity of the light beam coming through the pinhole made in the pinhole plate 17.

The half-mirror 13 reflects the light beam reflected from the surface of the sample 3 and applies it to the image-forming lens 16. The image-forming lens 16 focuses the light beam. The light beam thus focused passes through the pinhole made in the plate 17, reaching the light-receiving element 18. The light-receiving element 18 detects the intensity of the light beam and generates a light-intensity signal.

The SPM unit 9 provides a scanning-probe microscope image (hereinafter referred to as SPM image), i.e., physical-property data that contains the data representing the shape of the sample 3. The SPM unit 9 has a cantilever 19. A probe stylus 20 is attached to the free end of the cantilever 19. The SPM unit 9 incorporates a scanner and a displacement sensor. The scanner scans the cantilever in the X-axis and Y-axis directions and performs Z-axis servo control. The displacement sensor detects the displacement of the cantilever 19.

The displacement sensor is of so-called optical-lever type and detects the displacement of the cantilever 19. It has a light source and a light-receiving element. The light source applies a light beam to the cantilever 19. The light-receiving element detects the position of the light beam reflected by the cantilever 19.

The SPM unit 9 incorporates a Z-axis drive mechanism (not shown) that moves the probe stylus 20 toward the sample 3.

The control system of the compound microscope will be described. As FIG. 1 shows, the control system comprises a central processing unit (hereinafter referred to as CPU) 21, a control unit 22, a storage unit 23, an instruction input unit 24 and a display unit 25. The units 22, 23, 24 and 25 are connected to the CPU 21. The control unit 22 controls the compound microscope. The storage unit 23 has a RAM 23a and a ROM 23b. The RAM 23a stores various data items acquired in the compound microscope. The ROM 23b stores programs and the like. The instruction input unit 24 has a mouse, a keyboard and the like. The display unit 25 has a liquid crystal display. The CPU 21, storage unit 23, instruction input unit 24 and display unit 25 is, for example, a personal computer.

The control unit 22 controls the SPM unit 9 and the scanning laser microscope unit 10, making them acquire data about the sample 3.

The RAM 23a has an optical-microscope image memory 23a-1 and an SPM image memory 23a-2. The optical-microscope image memory 23a-2 stores the shape data acquired by the scanning laser microscope unit 10 and representing the shape of the sample 3. The SPM image memory 23a-2 stores the image data acquired by the SPM unit 9 and representing the SPM image of the sample 3.

The ROM 23b stores various programs. Among these programs are an optical-microscope operating program, an SPM operating program, a shape-data analyzing program, and a physical-property analyzing program. The optical-microscope operating program is used to control the scanning laser microscope unit 10. The SPM operating program is used to control the SPM unit 9. The shape-data analyzing program is use to analyze the shape data acquired by the scanning laser microscope unit 10. The physical-property analyzing program is used to analyze the physical-property data acquired by the SPM unit 9.

When operated, the instruction input unit 24 generates an instruction for changing the operating conditions of the scanning laser microscope unit 10, an instruction for changing the operating conditions of the SPM unit 9, and an instruction for changing the conditions of analyzing the shape data about the sample 3. The unit 24 further generates an instruction for analyzing the SPM image of the sample 3 and an instruction for switching the image on the display unit 25.

The CPU 21 has a multi-task function, performing several processes at the same time. The CPU 21 analyzes the SPM image provided by the SPM unit 9, while the scanning laser microscope unit 10 is acquiring the image data. That is, the CPU 21 simultaneously executes the physical-property analyzing program and the optical-microscope operating program stored in the ROM 23b.

The CPU 21 analyzes the shape data about the sample 3, acquired by the scanning laser microscope unit 10, while the SPM unit 9 is acquiring the image data. In other words, the CPU 21 simultaneously executes the shape-data analyzing program and the SPM operating program.

The CPU 21 functions as analysis unit. More specifically, the CPU 21 analyzes the shape data about the sample 3, acquired by the scanning laser microscope unit 10, or the SPM image provided by the SPM unit 9. Thus, the CPU 21 generates at least one of data items. representing a section of the sample 3, the roughness thereof, the length thereof, the results of a filtering process and the results of an inclination-adjusting process.

The CPU 21 makes the display unit 25 display the results of the analysis of the SPM image provided by the SPM unit 9, while the scanning laser microscope unit 10 is acquiring the shape data about the sample 3. The CPU 21 makes the display unit 25 display the results of the analysis of the shape data about the sample 3, provided by the scanning laser microscope unit 10, while the SPM unit 9 is acquiring the SPM image of the sample 3.

Controlled by the CPU 21, the display unit 25 displays one or more of the data items on the same screen. The data items are: the conditions of operating the SPM unit 9 and scanning laser microscope unit 10; the shape data acquired by the scanning laser microscope unit 10; the physical-property data acquired by the SPM unit 9; and the results of analysis performed by the CPU 21 (i.e., results of analysis performed on the shape data and SPM image of the sample 3).

When the scanning laser microscope unit 10 finishes acquiring the shape data about the sample 3, while the CPU 10 is analyzing the physical-property data acquired by the SPM unit 9, the display unit 25 displays the shape data about the sample 3 that the unit 10 has just acquired.

When the SPM unit 9 finishes acquiring the physical-property data about the sample 3 while the CPU 10 is analyzing the shape data about the sample 3 acquired by the scanning laser microscope unit 10, the display unit 25 displays the physical-property data that the SPM unit 9 has just acquired.

As FIG. 3 shows, the display unit 25 can display a control-menu screen D, which helps the operator to change the conditions of operating the SPM unit 9 or the scanning laser microscope unit 10. The control-menu screen D has a condition display region (first display region) F₁ and a data display region (second display region) F₂. Operating conditions are displayed in the condition display region F₁. The shape data about the sample 3, acquired by the scanning laser microscope unit 10, or the physical-property data about the sample 3, acquired by the SPM unit 9, are displayed in the data display region F₂.

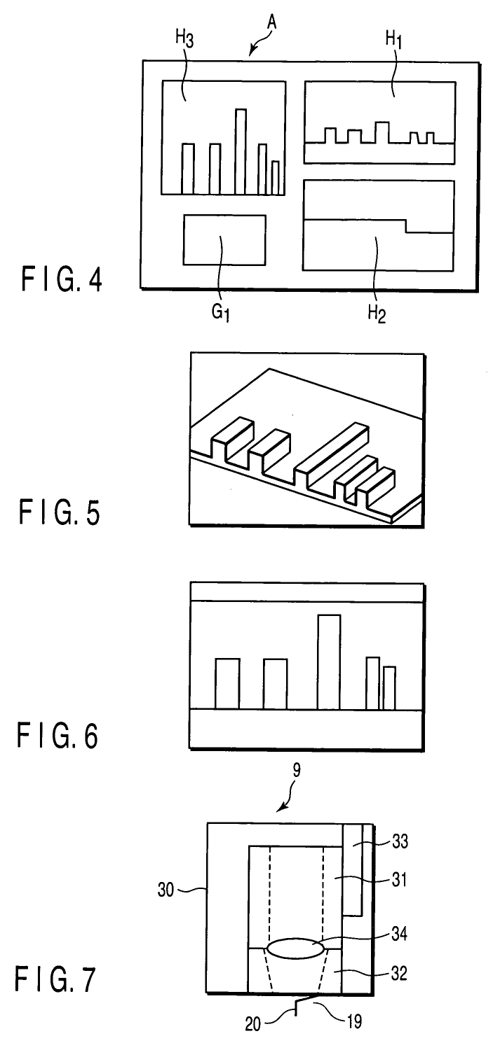

As FIG. 4 shows, the display unit 25 can display an analysis-result screen A. On the analysis-result screen A, there is displayed the shape data about the sample 3, acquired by the scanning laser microscope unit 10, or the results of various analyses that the CPU 21 has performed on the SPM image provided by the SPM unit 9.

The analysis-result screen A has an analysis-condition display frame (first analysis-condition -display region) G₁, an X-section analysis display frame (second first analysis-condition display region) H₁, a Y-section analysis display frame H₂, and a top-view display frame H₃.

Data for changing the conditions in which the CPU 21 analyzes data and images are displayed in the analysis-condition display frame G₁. The results of the analysis performed by the CPU 21, e.g., the analysis of the X-axis cross section of the sample 3, are displayed in the X-section analysis display frame H₁. The results of analysis of the Y-axis cross section of the sample 3 are displayed in the Y-section analysis display frame H₂. The image of the sample 3, as viewed from above, is displayed in the top-view display frame H₃.

How the compound microscope operates will be described.

First, the operator operates the instruction input unit 24, inputting the instruction that the display unit 25 should display the control-menu screen D. On receiving this instruction, the CPU 21 causes the display unit 21 to display the control-menu screen D (FIG. 3) for the scanning laser microscope unit 10. In the condition display region F₁ displayed in the control-menu screen D, the position of the objective lens 8, the size of a scanned area and the like are displayed. In the data display frame F₂, the image of the sample 3, acquired by the scanning laser microscope unit 10, is displayed.

The operator further operates the instruction input unit 24, inputting desirable conditions of acquiring data about the sample 3. In accordance with the data-acquisition conditions thus input, the CPU 21 generates an acquisition-start instruction to the scanning laser microscope unit 10.

In the scanning laser microscope unit 10 that as received the acquisition-start instruction, the light source 11 emits a laser beam. The laser beam travels through the beam expander 12, half-mirror 13, first galvano-mirror 14 and second galvano-mirror 15. The laser beam is applied to the objective lens 8. The objective lens 8 focuses the laser beam on the sample 3. As the first and second galvano-mirrors 14 and 15 are moved, the beam spot moves on the sample 3 in the X- and Y-axis directions. Raster scanning is thereby accomplished.

The sample 3 reflects the laser beam, which travels back to the half-mirror 13. The half-mirror 13 reflects the beam, guiding it to the image-forming lens 16. The lens 16 focuses the beam at the pinhole made in the pinhole plate 17.

The laser beam reflected by the sample 3 passes the pinhole only if the sample 3 has its surface located at or near the focal point of the objective lens 8. If the surface of the sample 3 is far from the focal point of the objective lens 8, the laser beam cannot pass through the pinhole. It can pass through the pinhole when the laser beam is focused at the very surface of the sample 3.

The light beam reflected passes through the pinhole and reaches the light-receiving element 18. The element 8 detects the intensity of the light beam and generates a signal representing the intensity of the beam.

The CPU 21 receives the signal output from the light-receiving element 18 and representing the intensity of the light beam. The CPU 21 processes this signal and the data representing the XY position where the laser beam is focused in the raster scanning performed by the first and second galvano-mirrors 14 and 15. As a result, the CPU 21 determines the Z position where the laser beam is focused, thus acquiring an image of that part of the sample 3 which lies in the plane containing the point where the laser beam is focused.

Every time the raster scanning is carried out, obtaining an image of the sample 3, the CPU 21 makes the Z-drive mechanism 6 move the objective lens 8 in the Z-axis direction by a predetermined distance. Thus, as the raster scanning is repeated, the CPU 21 acquires height data and processes this data, acquiring a two-dimensional or three-dimensional shape data about the sample 3. The a two-dimensional or three-dimensional shape data is stored in the optical-microscope image memory 23a-1.

The CPU 21 generates data representing such a three-dimensional image as shown in FIG. 5 or such an extended focus image as shown in FIG. 6. This data is supplied to the display unit 25, which displays the three-dimensional image or the extended focus image.

The extended focus image of FIG. 6 is obtained when the laser beam is focused at various parts of the sample 3, which lie at different heights. The extended focus image is provided by combining the optical microscope images of various parts of the sample 3, at which the laser beam is focused.

Next, the SPM unit 9 acquires the image data representing that part of the sample 3 that is almost identical to the part of which data has been acquired by the scanning laser microscope unit 10.

In the control-menu screen D (FIG. 3) for the scanning laser microscope unit 10, the switching to the SPM mode is displayed in the condition display region F₁ when the operator operates the instruction input unit 24, instructing that the SPM unit 9 should acquire image data of the sample 3. On receiving this instruction, the CPU 21 controls the revolver 7. The revolver 7 rotates, moving the SPM unit 9 to a position where the SPM unit 9 faces the sample 3.

The CPU 21 gives an instruction to the display unit 25, instructing that the unit 25 should display the condition display region F₁. Thus, the display unit 25 displays the control-menu screen D (FIG. 3). As indicated above, the screen D has the condition display region F₁ and the data display region F₂. SPM-analysis conditions and the SPM image provided by the SPM unit 9 are displayed in the display regions F₁ and F₂, respectively.

The operator operates the instruction input unit 24, setting SPM-analysis conditions and instructing that the SPM unit 9 should start performing SPM analysis on the sample 3. On receiving this instruction, the CPU 21 sets data-acquisition parameters in the control-menu screen D. Thereafter, the CPU 21 instructs the SPM unit 9 to acquire the image data of the sample 3.

The SPM unit 9 moves the cantilever 19 having the probe stylus 20, in the X- and Y-axis directions. At the same time, the SPM unit 9 undergoes a servo control, moving in the Z-axis direction. The displacement sensor of the SPM unit 9 detects the displacement of the cantilever 19. The light source of the displacement sensor applies a light beam to the cantilever 19. The light-receiving element of the displacement sensor detects the position of the light beam reflected by the cantilever 19 and generates a signal representing this position.

The CPU 21 receives the signal from the displacement sensor, acquiring an SPM image of the sample 3. The CPU 21 generates data representing the SPM. This data is stored in the SPM image memory 23a-2.

During the SPM unit 9 is acquiring the image data, the operator may operate the instruction input unit 24, instructing that the two-dimensional or three-dimensional shape data about the sample 3, acquired by the scanning laser microscope unit 10, be analyzed. Then, the CPU 21 causes the display unit 25 to display an analysis-result screen A, as is illustrated in FIG. 4.

Buttons for selecting a two-dimensional shape data and a three-dimensional shape data, respectively, and various conditions of analyzing the shape data selected are displayed in the of analysis-condition display frame G₁ in the analysis-result screen A. Note that either shape data has been acquired by the scanning laser microscope unit 10 and represents the two- or three-dimensional image of the sample 3.

The CPU 21 reads the two- or three-dimensional shape data about the sample 3 from the optical-microscope image memory 23a-1, in accordance with the shape-data selection button and the conditions of analyzing, all set and displayed in the analysis-condition display frame G₁. The CPU 21 then analyzes the two- or three-dimensional shape data read from the memory 23a-1.

For example, the CPU 21 analyzes the two- or three-dimensional shape data in terms of the surface roughness of the sample 3 or the length of each part of the sample 3. In addition, the CPU 21 performs a filtering process to reduce the image noise, and an inclination-adjusting process to adjust the inclination of the image.

As FIG. 4 shows, the CPU 21 causes the display unit 25 to display the X-axis cross section of the sample 3 in the X-section analysis display frame H₁, and the Y-axis cross section of the sample 3 in the Y-section analysis display frame H₂. The CPU 21 causes the display unit 25 to display to display the top view of the sample 3 in the top-view display frame H₃.

FIG. 4 shows the results of the analyses performed on the two- or three-dimensional shape data, too. The frames in which the analysis results are displayed can be re-arranged, if necessary in accordance with the analyses performed. The display unit 25 can display the lengths analyzed of various parts shown in a two-dimensional image, the results of the filtering process for reducing the image noise, the results of the inclination-adjusting process for adjusting the inclination of the image.

How the scanning laser microscope unit 10 acquires data about the sample 3 will be explained again.

In the same way as described above, the scanning laser microscope unit 10 carries out raster scanning on the sample 3 by applying a laser beam to the sample 3. The light beam reflected from the sample 3 passes through the pinhole of the pinhole plate 17, reaching the light-receiving element 18. The element 18 generates a signal representing the intensity of the light beam. The CPU 21 receives this signal and generates data that represents an optical-microscope image of a part of the sample 3. Every time the raster scanning is carried out, obtaining an image of the sample 3, the CPU 21 makes the Z-drive mechanism 6 move the objective lens 8 in the Z-axis direction by a predetermined distance. As the raster scanning is so repeated, the CPU 21 acquires three-dimensional shape data about the sample 3.

While the laser microscope unit 10 is acquiring the two- or three-dimensional shape data about the sample 3, the operator may operate the instruction input unit 24, instructing that the SPM image of the sample 3, acquired by the SPM unit 9, be analyzed. In this case, the CPU 21 causes the display unit 25 to display an analysis-result screen A, as is illustrated in FIG. 4. Buttons for selecting the SPM image of the sample 3 and various conditions of analyzing the SPM image are displayed in the of analysis-condition display frame G₁ in the analysis-result screen A.

The CPU 21 reads the data representing an SPM image from the SPM image memory 23a-2, in accordance with the SPM-image selection button and the SPM-image analyzing conditions, all set and displayed in the analysis-condition display frame G₁. For example, the CPU 21 analyzes the SPM image of the sample 3 in terms of the surface roughness of the sample 3 or the length of each part of the sample 3. Further, the CPU 21 performs a filtering process to reduce the image noise, and an inclination-adjusting process to adjust the inclination of the image.

In the first embodiment described above, the CPU 21 analyzes the two- or three-dimensional shape data about the sample 3, acquired by the scanning laser microscope unit 10, while the SPM unit 9 is acquiring an SPM image of the sample 3. The CPU 21 makes the display unit 25 display the results of the analysis of the two- or three-dimensional shape data about the sample 3. While the scanning laser microscope unit 10 is acquiring a two- or three-dimensional shape data about the sample 3, the CPU 21 analyzes the SPM image of the sample 3, which the SPM unit 9 has provided, and causes the display unit 25 to display the results of the analysis.

Thus, the results of the analysis of the two- or three-dimensional shape data about the sample 3, acquired by the scanning laser microscope unit 10, can be displayed while the SPM unit 9 is acquiring the image data of the sample 3. This has been impossible hitherto. The analysis of two- or three-dimensional shape data about the sample 3 results in images of, for example, the X-axis cross section, Y-axis cross section and top of the sample 3. On the basis of the results of the analysis of the two- or three-dimensional shape data about the sample 3, the surface roughness of the sample 3 is analyzed, the length of each part of the sample 3 is determined. Further, various image-processing methods, such as a filtering process of reducing the image noise and an inclination-adjusting process of adjusting the inclination of the image, are carried out.

The SPM image of the sample 3, provided by the SPM unit 9, can be analyzed and the results of this analysis can be displayed, while the scanning laser microscope unit 10 is acquiring data about the sample 3. The analysis of the SPM image results in images of, for example, the X-axis cross-section, Y-axis cross-section and top of the sample 3. On the basis of the results of the analysis of the SPM image, the surface roughness of the sample 3 is analyzed, the length of each part of the sample 3 is determined. Further, various image-processing methods, such as a filtering process of reducing the image noise and an inclination-adjusting process of adjusting the inclination of the image, are carried out.

Thus, the scanning laser microscope unit 10 can use the time during which the SPM unit 9 remains in standby state, and the SPM unit 9 can operate while the scanning laser microscope unit 10 is acquiring data about the sample 3.

A second embodiment of this invention will be described, with reference to FIG. 7. The components identical to those shown in FIG. 1 are designated at the same reference numerals in FIG. 7 and will not be described in detail.

FIG. 7 illustrates the SPM unit 9 incorporated in a compound microscope according to the second embodiment. The SPM unit 9 has a hollow cylindrical body 30. A scanner 31 and a displacement sensor 32 are provided in the inner surface of the body 30. A cantilever 19 is secured at one end to the lower edge of the displacement sensor 32. A probe stylus 20 is attached to the free end of the cantilever 19.

The scanner 31 scans the cantilever 19 in the X-axis and Y-axis directions and performs Z-axis servo control. The displacement sensor 32 is of so-called optical-lever type and detects the displacement of the cantilever 19. The sensor 32 has a light source and a light-receiving element. The light source applies a light beam to the cantilever 19. The light-receiving element detects the position of the Light beam reflected by the cantilever 19.

In the hollow cylindrical body 30, a Z-axis drive mechanism 33 is provided. The mechanism 33 moves the probe stylus 20 toward the sample 3.

An objective lens 34 is provided in the hollow cylindrical body 30. The objective lens 34 is used in place of the objective lens 8 of the scanning laser microscope unit 10 (FIG. 2), when the revolver 7 moves the SPM unit 9 to a position where the SPM unit 9 faces the sample 3.

Hence, the scanning laser microscope unit 10 can acquire a two- or three-dimensional shape data about the sample 3, using the objective lens 34, while the SPM unit 9 remains selected and operating.

The operator may operate the instruction input unit 24, switching the SPM mode to the optical-microscope mode. Then, the CPU 21 causes the display unit 25 to stop displaying the control-menu screen D for the SPM unit 9 and start displaying the control-menu screen D for the scanning laser microscope unit 10. At the same time, the CPU 21 instructs the scanning laser microscope unit 10 to start operating.

The operator may operate the instruction input unit 24, conversely switching the optical-microscope mode to the SPM mode. In this case, the CPU 21 causes the display unit 25 to stop displaying the control-menu screen D for the scanning laser microscope unit 10 and start displaying the control-menu screen D for the SPM 9. At the same time, the CPU 21 instructs the SPM unit 9 to start operating.

How the compound microscope operates will be described in detail.

As long as the SPM unit 9 remains selected and facing the sample 3, the display unit 25 displays the control-menu screen D for the SPM unit 9, as illustrated in FIG. 3.

Before or after the data acquisition by the SPM 9, the operator may want to determine whether the probe stylus 20 takes a desired position with respect to the sample 3. In this case, the operator operates the instruction input unit 24, switching the SPM mode to the optical-microscope mode. The CPU 21 therefore causes the display unit 25 to stop displaying the control-menu screen D for the SPM unit 9 and starts displaying the control-menu screen D for the scanning laser microscope unit 10, and instructs the scanning laser microscope unit 10 to start operating.

Thus, the scanning laser microscope unit 10 uses the objective lens 34, acquiring a two- or three-dimensional shape data about the sample 3, though the SPM unit 9 faces the sample 3.

The CPU 21 analyzes the two- or three-dimensional shape data about the sample 3 acquired by the use of the objective lens 34. The positional relation between the sample 3 and the probe stylus 20 can therefore be determined.

Conversely, the operator may switch the optical-microscope mode to the SPM mode. In this case, the objective lens 8 is moved to the position where it faces the sample 3. The CPU 21 causes the display unit 25 to stop displaying the control-menu screen D for the scanning laser microscope unit 10 and start displaying the control-menu screen D for the SPM unit 9. At the same time, the CPU 21 instructs the SPM unit 9 to start operating.

The CPU 21 does not immediately start acquiring data about the sample 3. It switches the control-menu screen, from the one for the scanning laser microscope unit 10 to the one for the SPM unit 9, after completing the data acquisition by using the objective lens 34 incorporated in the SPM unit 9. Thereafter, the CPU 21 causes the SPM unit 9 to acquire data.

In the second embodiment, the SPM unit 9 incorporates an objective lens 34. The objective lens 34 enables the scanning laser microscope unit 10 to acquire a two- or three-dimensional shape data about the sample 3 even if the SPM unit 9 faces the sample 3.

The present invention is not limited to the first and second embodiments. Various modifications can be made.

For example, the optical microscope may be an optical microscope unit such as a bright-field microscope, a dark-field microscope, an incident-light microscope, a transmission microscope, a polarizing microscope, an interference microscope, or a confocal laser microscope. If the optical microscope is such an optical microscope unit, the data representing a two-dimensional image the light-receiving element (e.g., CCD sensor) has received from the optical microscope unit is stored in the storage unit 23. This brings forth the same advantage as in the second embodiment.

The mechanism for switching between the objective lens 8 and the SPM unit 9 may be attained if the SPM unit 9, for example, is removed from the optical microscope unit 5 and secured to the gantry frame 4. If this is the case, the XY stage 2 is an electrically driven stage that helps to detect XY coordinates, and the sample 3 is placed below the objective lens 8 or the SPM unit 9.

What is claimed is:

1. A compound microscope comprising:
an optical microscope which acquires image data representing an image of an sample;
a scanning probe microscope which acquires physical-property data representing physical properties of the sample;
a storage unit which stores the image data and the physical-property data acquired by the optical microscope and the scanning probe microscope, respectively;
a data-analyzing unit which analyzes the physical-property data stored in the storage unit, while the optical microscope is acquiring the image data, and which analyzes the image data stored in the storage unit, while the scanning probe microscope is acquiring the physical-property data; and
a display unit which displays results of analysis that the data-analyzing unit performs on the physical-property data, while the optical microscope is acquiring the image data, and which displays results of analysis that the data-analyzing unit performs on the image data, while the scanning probe microscope is acquiring the physical-property data.

2. A compound microscope comprising:
an optical microscope which acquires shape data representing an at least two-dimensional image including an optical image of a sample;
a scanning probe microscope which acquires physical-property data containing shape data about the sample;
a data-acquiring condition setting unit which sets and changes at least conditions in which the optical microscope and the scanning probe microscope acquire the shape data and the physical-property data, respectively;
a storage unit which stores the shape data and the physical-property data acquired by the optical microscope and scanning probe microscope, respectively;
a data-analyzing unit which analyzes the physical-property data stored in the storage unit, while the optical microscope is acquiring the shape data, and which analyzes the shape data stored in the storage unit, while the scanning probe microscope is acquiring the physical-property data; and
a display unit which displays results of analysis that the data-analyzing unit performs on the physical-property data, while the optical microscope is acquiring the shape data, and which displays results of analysis that the data-analyzing unit performs on the shape data, while the scanning probe microscope is acquiring the physical-property data.

3. The compound microscope according to claim 2, wherein the data-analyzing unit analyzes the shape data or the physical-property data, thereby acquiring at least one of data items representing, respectively, a cross section of the sample, surface roughness of the sample, length of the sample, results of a filtering process, and results of an inclination-adjusting process.

4. The compound microscope according to claim 2, wherein the display unit displays, in one screen, at least one of the conditions in which the optical microscope acquires the shape data, the conditions in which the scanning probe microscope acquires the physical-property data, the shape data acquired by the optical microscope, the physical-property data acquired by the scanning probe microscope and the results of the analysis performed by the data-analyzing unit.

5. The compound microscope according to claim 2, wherein the display unit displays the shape data when the optical microscope finishes acquiring the shape data while the data-analyzing unit is analyzing the physical-property data acquired by the scanning probe microscope.

6. The compound microscope according to claim 2, wherein the display unit displays the physical-property data when the scanning probe microscope finishes acquiring the physical-property data while the data-analyzing unit is analyzing the shape data acquired by the optical microscope.

7. The compound microscope according to claim 2, wherein the display unit displays a data-acquisition screen which enables an operator to change the conditions in which the optical microscope acquired the shape data the conditions in which the scanning probe microscope acquires the physical-property data.

8. The compound microscope according to claim 7, wherein the data-acquisition screen has a first display region in which the conditions, and a second display region for displaying the shape data acquired by the optical microscope or the physical-property data acquired by the scanning probe microscope.

9. The compound microscope according to claim 2, wherein the display unit displays an analysis screen in which the results of the analysis performed by the data-analyzing unit are displayed.

10. The compound microscope according to claim 9, wherein the analysis screen has a first display region in which operating conditions of the data-analyzing unit are changed, and a second display region in which the results of the analysis performed by the data-analyzing unit are displayed.

11. The compound microscope according to claim 1, in which the optical microscope has at least one objective lens, the scanning probe microscope has a scanning-probe microscope unit configured to acquire the physical-property data containing shape data about the sample, and which further comprises a drive mechanism which moves the sample, the objective lens and the scanning-probe microscope unit relative to one another, causing the objective lens or the scanning-probe microscope unit to face the sample.

12. The compound microscope according to claim 11, wherein the scanning-probe microscope unit incorporates an optical lens configured to acquire shape data that represents an at least two-dimensional image of the sample.

13. The compound microscope according to claim 2, in which the optical microscope has at least one objective lens, the scanning probe microscope has a scanning-probe microscope unit configured to acquire the physical-property data containing shape data about the sample, and which further comprises a drive mechanism which moves the sample, the objective lens and the scanning-probe microscope unit relative to one another, causing the objective lens or the scanning-probe microscope unit to face the sample.

14. The compound microscope according to claim 13, wherein the scanning-probe microscope unit incorporates an optical lens configured to acquire shape data that represents an at least two-dimensional image of the sample.

15. The compound microscope according to claim 1, wherein the optical microscope has a scanning laser microscope configured to acquire image data representing a three-dimensional image of the sample.

16. The compound microscope according to claim 2, wherein the optical microscope has a scanning laser microscope configured to acquire image data representing a three-dimensional image of the sample.

17. A method of analyzing a sample by using a compound microscope that comprises an optical microscope, a scanning probe microscope, a storage unit and a display unit, said method comprising:
acquiring image data representing an image of the sample by using the optical microscope;
acquiring physical-property data representing physical properties of the sample by using the scanning probe microscope;
storing the image data in the storage unit as the optical microscope acquires the image data;
storing the physical-property data in the storage unit as the scanning probe microscope acquires the physical-property data;
analyzing the physical-property data stored in the storage unit, while the optical microscope is acquiring the image data, and displaying results of analysis performed on the physical-property data;
analyzing the image data stored in the storage unit, while the scanning probe microscope is acquiring the physical-property data, and displaying results of analysis performed on the image data.

18. The method according to claim 17, wherein the optical microscope acquires the image data about the sample via an objective lens incorporated in the scanning probe microscope after data acquisition by the optical microscope has been switched to data acquisition by the scanning probe microscope.
